(19) United States
(12) Patent Application Publication
(10) Pub. No.: US 2023/0283709 A1
(43) Pub. Date: Sep. 7, 2023

(54) DIGITAL HABIT TRAINER SYSTEM

(71) Applicant: Danyel Baker, Naples, FL (US)

(72) Inventor: Danyel Baker, Naples, FL (US)

(21) Appl. No.: 18/117,116

(22) Filed: Mar. 3, 2023

Related U.S. Application Data
(60) Provisional application No. 63/316,146, filed on Mar. 3, 2022.

(51) Int. Cl. H04M 1/72466; H04M 1/72451; H04M 1/72484; H04M 1/72409

(52) U.S. Cl. CPC H04M 1/72466; H04M 1/72451; H04M 1/72484; H04M 1/724095

(57) ABSTRACT

A system for providing digital habit reminders via a user computing device is disclosed, including at least one user computing device in operable connection with a user network. An application server is in operable communication with the user network to host an application system for providing digital habit reminders. The application system includes a user interface module for providing access to the application program through the user computing device. A habit module is in communication with the application program to permit input of at least one habit and to deliver, via a communication module, an alert associated with the at least one habit to the user computing device. A timing module permits the input of a time interval associated with each of the at least one habits, via the communication module, at the time interval.

### CROSS-REFERENCE TO RELATED APPLICATIONS

The present application claims priority to U.S. Provisional Application No. 63/316,146 filed Mar. 3, 2022, titled “DIGITAL HABIT TRAINER APPLICATION,” which is hereby incorporated by reference in its entirety.

### TECHNICAL FIELD

Embodiments of the invention relate to systems and methods for digital habit trainer applications.

### BACKGROUND

Positive habit formation is a key to success for many people in all manner of different professions and their personal lives. However, habit formation can be challenging, especially given the number of distractions and randomness of events that many people have in their lives. As such, it can be difficult to remember particular actions and thoughts that a person wishes to engage in on a repetitive manner so that they become positive habits. In the past, people might wear a rubber band or bracelet as a visual reminder, take notes in a journal for review at the end of the day or week, or engage in other systems or methods to try and remember the habits they wish to form or engage in. However, these prior systems and methods are passive and may not perform well for people with an active life or who are very busy.

Thus, it would be beneficial to provide systems and methods for positive habit formation using mobile and wearable devices.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

A system for providing digital habit reminders via a user computing device is disclosed, including at least one user computing device in operable connection with a user network. An application server is in operable communication with the user network to host an application system for providing digital habit reminders. The application system includes a user interface module for providing access to the application program through the user computing device. A habit module is in communication with the application program to permit input of at least one habit and to deliver, via a communication module, an alert associated with the at least one habit to the user computing device. A timing module permits the input of a time interval associated with each of the at least one habits, via the communication module, at the time interval.

The systems and methods described herein provide a habit trainer application for a user device that can provide reminders for positive habit training, particularly in the time management, health and wellness, and other industries. These systems and methods can include incorporating a habit trainer application that generates a habit block by allowing a user to set a habit notification word, a time frame, and interval parameters.

In one aspect, the systems and methods described herein allow for the user to establish a habit training regimen that allows for the training of habits and/or the untraining of habits.

In one aspect, users may activate and/or deactivate one or more habits or groups of habits. In such, the user may selectively reactivate previously deactivated habits.

The application may also utilize an interval system to send an alert, such as the habit notification word, to the user. The alert is a notification on and/or to a mobile or electronic device, such as a smartwatch and/or a smartphone. The notification can include a sound alert or be silent, with or without vibration of the electronic device. The notification presents a notification screen with an alert dismiss button. For each habit block, the application tracks how many days the user has been training the corresponding habit. When a user feels that a habit has been formed or mastered, the user can remove or deactivate the corresponding habit block. The user can reactivate a previously deactivated habit block.

The application has an interface with a maximum number of habit blocks appearing per page. For example, the application can limit the habit blocks per page up to 4 habit blocks. When a user has more than the maximum number of habit blocks per page (e.g., more than 4 habit blocks), new pages are generated until all habit blocks have a corresponding page. The user can switch between pages to select a particular habit by clicking the habit block corresponding to the particular habit.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2A illustrate a user interface screen of a mobile application, according to some embodiments;

FIG. 2B illustrate a user interface screen of a mobile application, according to some embodiments;

FIG. 2C illustrate a user interface screen of a mobile application, according to some embodiments;

FIG. 2D illustrate a user interface screen of a mobile application, according to some embodiments;

FIG. 2E illustrate a user interface screen of a mobile application, according to some embodiments;

FIG. 3A illustrate a user interface screen of a wearable device, according to some embodiments;

FIG. 3B illustrate a user interface screen of a wearable device, according to some embodiments;

FIG. 3C illustrate a user interface screen of a wearable device, according to some embodiments; and

FIG. 3D illustrate a user interface screen of a wearable device, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a habit training system for a user device that can provide reminders for positive habit training, particularly in the time management, health and wellness, and other industries. These system can include incorporating a habit trainer application program that generates a habit block by allowing a user to set a habit notification word, a time frame, and interval parameters. The application program also uses an interval system to send an alert, such as the habit notification word, to the user.

As used herein, the term “alert” may be used to describe a visual alert on the display of the computing device, a sound, a vibration, lights, or other indication which can alert the user.

In some embodiments, habits input by the user may include habits the user wishes to develop as well as habits the user would like to untrain from using.

In some embodiments, the user may input a word, phrase, mantra, affirmation, etc. which is displayed to the user in a similar scheduled manner as the habit.

In some embodiments, the alert is a notification on and/or to a mobile or electronic device, such as a smartwatch and/or a smartphone. The notification can include a sound alert or be silent, with or without vibration of the electronic device to notify the user of successfully completing a task or practicing a habit, to remind the user to complete a particular task or to practice a habit, etc.

In some embodiments, the input of habits and/or phrases operates as a form of interval training. Users may input habit details, a time period, daily count, amount of time or interval, or other parameters during which the alert is transmitted.

In particular, the notification presents a notification screen with an alert dismiss button. For each habit block, the application tracks how many days the user has been training the corresponding habit. When a user feels that a habit has been formed or mastered, the user can remove or deactivate the corresponding habit block.

The user can reactivate a previously deactivated habit block. The application has an interface with a maximum number of habit blocks appearing per page. For example, the application can limit the habit blocks per page up to 4 habit blocks. When a user has more than the maximum number of habit blocks per page (e.g., more than 4 habit blocks), new pages are generated until all habit blocks have a corresponding page. The user can switch between pages to select a particular habit by clicking the habit block corresponding to the particular habit.

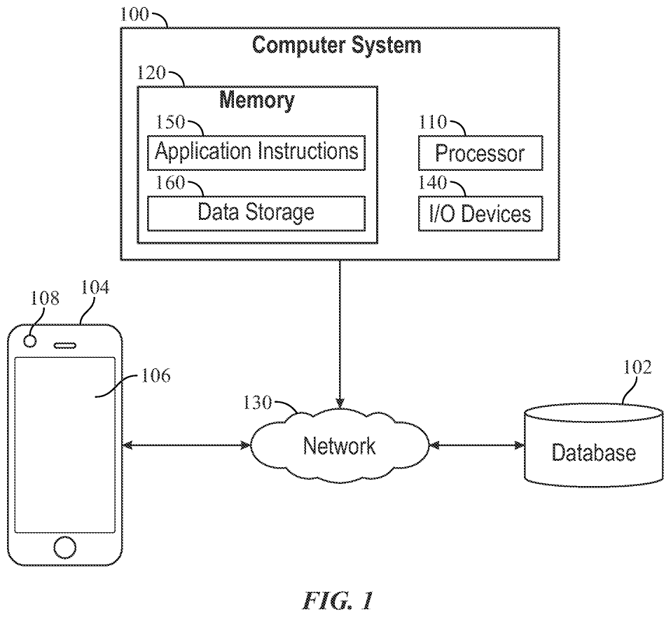

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, an eBook reader or dedicated digital reader device, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated. In instances where a server is provided, connection through network 130 can allow the server to store information in one or more databases that can be used for adaptive learning, artificial intelligence operations, machine learning, or others. Example databases include lesson database(s), client database(s), and others.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C #, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if the computer system 102 is mobile.

In some embodiments, the system is world-wide-web (www) accessible and/or based, and a network server can include a web server delivering HTML, XML, etc., web pages to the computing devices. In other embodiments, a client-server architecture may be implemented, in which a network server executes enterprise and custom software, exchanging data with custom client applications running on the computing device 102.

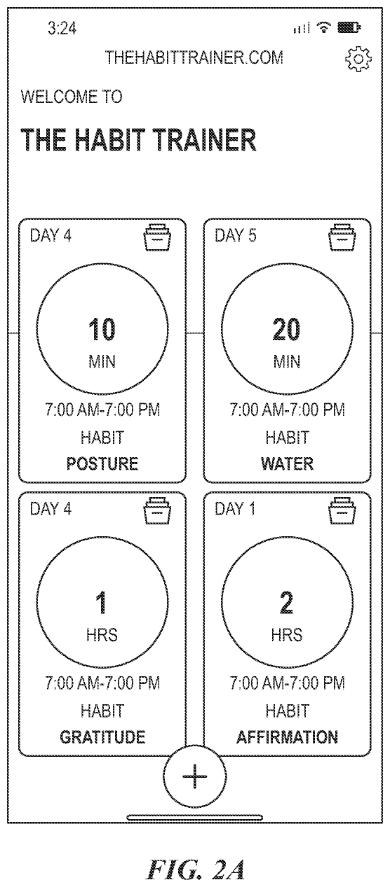

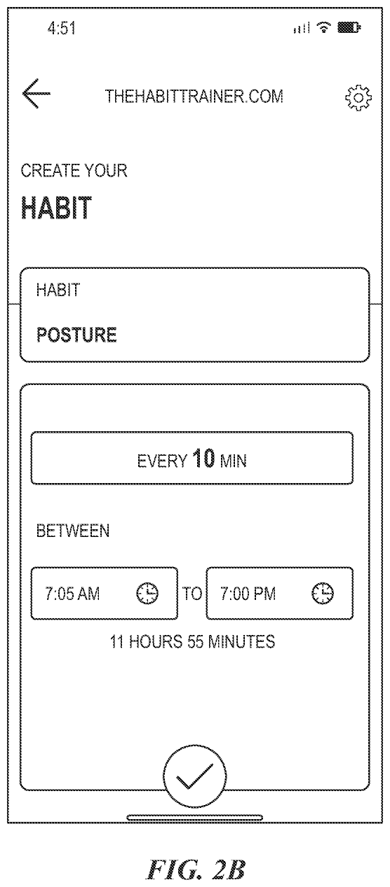

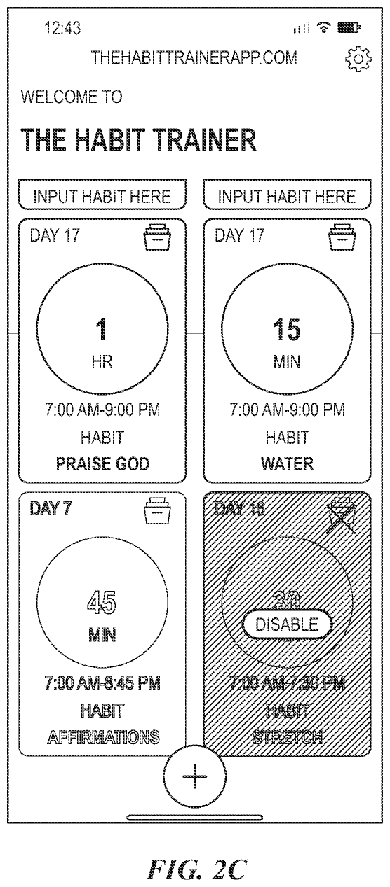

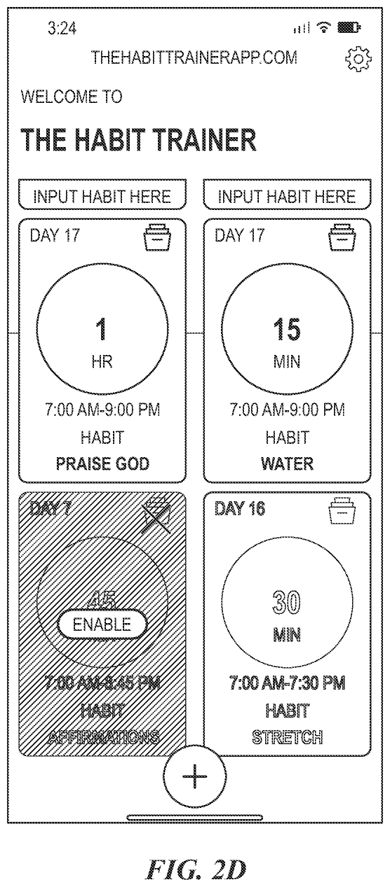

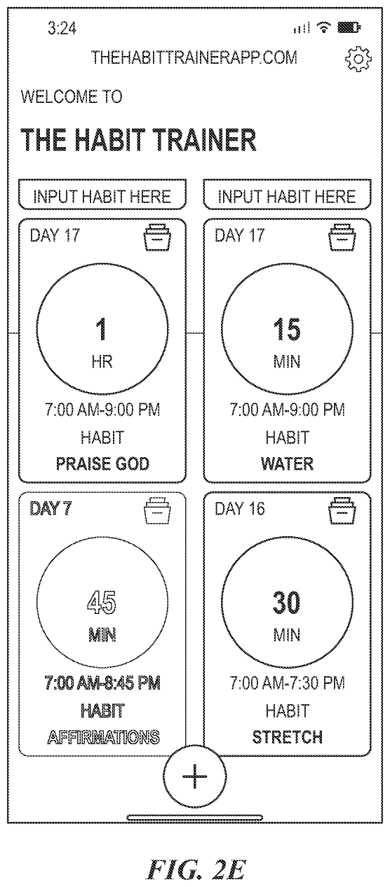

FIGS. 2A-2E illustrate a user interface screen of a mobile application, according to some embodiments.

As shown in FIG. 2A, a user interface screen of a mobile application can include at least one habit training overview display. In the example embodiment, four such overview displays are shown, one for a posture habit training overview display, one for a water habit training overview display, one for a gratitude habit training overview display, and one for an affirmation habit training overview display. Each of these habit training overview displays can include a time window, a daily count indicator, an amount of time indicator, and a selectable file icon that can allow users to select and view additional information about the particular habit. Also shown are selectable settings button and an add habit button. The settings button can allow a user to modify application settings when selected and the add habit button can allow a user to create a new habit when selected.

As shown in FIG. 2B, a user interface screen of a mobile application can include a habit creation screen. In the example embodiment, a user can enter a name or title for a habit, an alarm or reminder button to select or input a particular frequency that the reminder will occur (e.g., every 10 minutes), and one or more time window fields or dropdown menus that allow users to select when the reminder will be active (e.g., between 7:00 am and 7:00 pm). Also shown are a confirmation button that will create the selected habit reminder when selected and a back button that will take a user to a previous screen when selected. Those in the art will understand that reminders can occur in the form of device sounds, display notifications, vibrations, or other device indicators. In some embodiments indicators can be transmitted or set to occur on remote devices and may include network communication capability via a wired and/or wireless network over a protocol such as Wi-Fi, Bluetooth, or others via the Internet and/or other network.

As shown in FIG. 2C, a user interface screen of a mobile application can include the functionality to temporarily and/or permanently disable a particular habit training overview display. In the example embodiment, the user has selected a habit training overview display in the bottom right of the image. When selected the display changes to a dark shade and selectable buttons are shown to allow the user to disable or unselect the habit training overview display. If the user selects the disable button, the habit training overview display can turn a lighter shade to indicate that it is disable and show the normal information.

As shown in FIG. 2D, a user interface screen of a mobile application can include the functionality to enable a temporarily and/or permanently disabled habit training overview display.

In the example embodiment, the user has selected a habit training overview display in the bottom left of the image that was lightly shaded, indicating that it was disabled. When selected the display changes to a dark shade and selectable buttons are shown to allow a user to enable or unselect the habit training overview display. If the user selects the enable button, the habit training overview display can remove the shading and reestablish the normal functionality of the habit reminder.

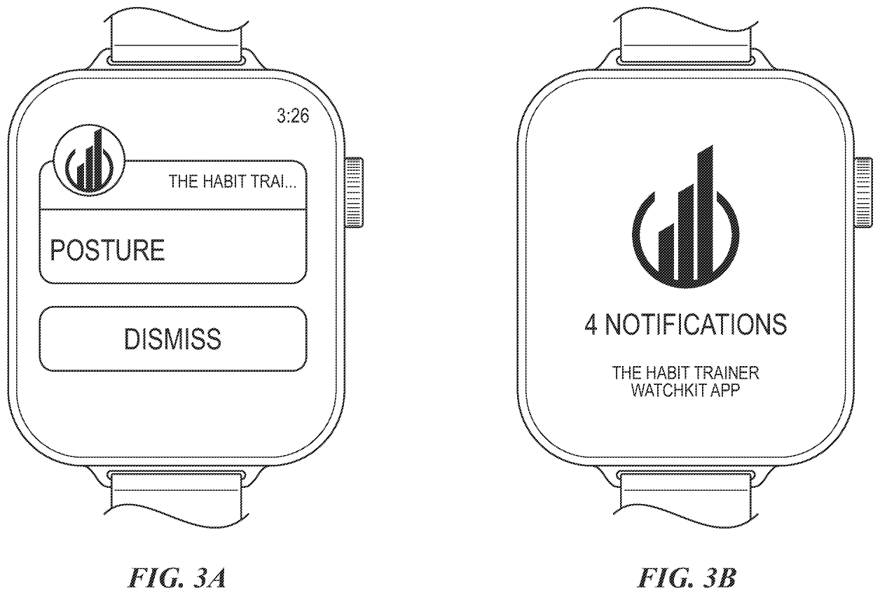

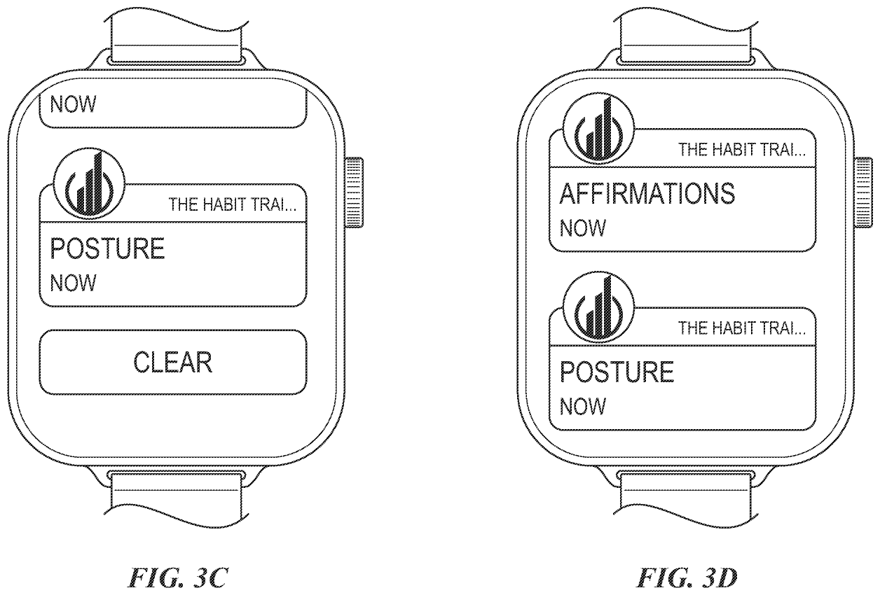

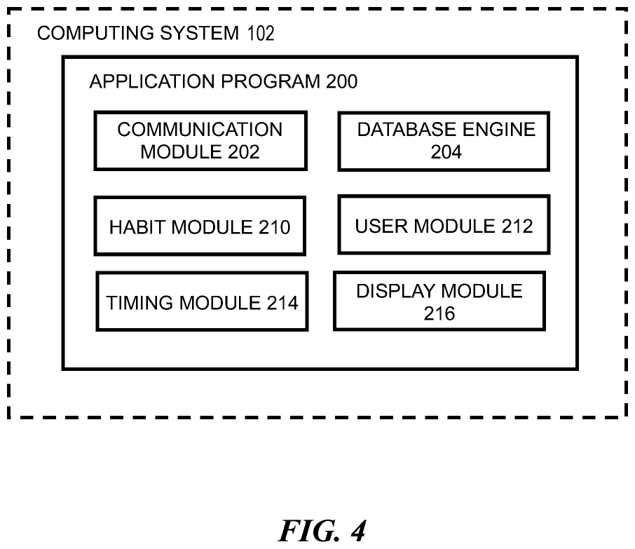

FIGS. 3A-3D illustrate a user interface screen of a wearable device, according to some embodiments. In various embodiments, the functionality of wearable device habit trainers can be controlled by a user on a smartphone or other device that is communicatively coupled to the wearable device, such that the user can create, edit, and set habit reminders from the other device and they will be transmitted over a network to the wearable device.

As shown in FIG. 3A, a user interface screen of a wearable device can include a reminder title or name that is displayed when a particular timer setting has expired. It can include a selectable button or other feature allowing a user to dismiss the reminder. The user may tap the screen (or perform another action or gesture) to view all notifications that have been sent over a period of time.

As shown in FIG. 3B, if multiple reminders need to be displayed to the user or have not been dismissed, a notification indicating the number of habit reminders pending can be displayed.

As shown in FIG. 3C, a habit reminder can include a clear button in some embodiments that clears the display of the habit reminder.

As shown in FIG. 3D, a habit reminder can include multiple reminders in some embodiments, which can be individually selected and reviewed by the user.

FIG. 4 illustrates an example computer architecture for the application program 200 operated via the computing system 102. The computer system 102 comprises several modules and engines configured to execute the functionalities of the application program 200, and a database engine 204 configured to facilitate how data is stored and managed in one or more databases. In particular, FIG. 4 is a block diagram showing the modules and engines needed to perform specific tasks within the application program 200.

Referring to FIG. 4, the computing system 102 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a habit module 210, a user module 212, a timing module 214, a display module 216.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the habit module 210 is configured to receive user input related to a habit via the user interface. Each habit may be associated with a time window, a daily count indicator, an amount of time indicator, and a selectable file icon that can allow users to select and view additional information about the particular habit. Further, the user may input a predetermined number of habits (e.g., four). Selectable settings may be provided via habit selection buttons, customizable buttons, and/or add habit buttons. The settings button can allow a user to modify application settings when selected and the add habit button can allow a user to create a new habit when selected.

In some embodiments, may allow the user to create a habit via the user interface. a habit creation screen by allowing the user to enter a name or title for a habit, an alarm or reminder button to select or input a particular frequency that the reminder will occur (e.g., every 10 minutes), and one or more time window fields or dropdown menus that allow users to select when the reminder will be active (e.g., between 7:00 am and 7:00 pm).

In some embodiments, the user module 212 facilitates the creation of a user account for the application system. The user module 212 may allow the user to create a user profile which includes user information, habits, and other user settings. In some embodiments, the user module permits the user to input one or more preferences corresponding to the at least one habit and the time interval, wherein the at least one habit and the time interval is stored in the database.

The user module 212 may permit a third-party user to access the application program and thereby input habits which are transmitted to one or more additional users. For example, the third-party user may be a school teacher who can input reminders for students to complete a task, habit, etc. The embodiments may be useful to teachers, coaches, parents, group leaders, etc.

In some embodiments, the timing module 214 is in operable communication with the computing device to permit the user to select a period of time for alerts to be transmitted, via the communication module 202. For example, alerts may be sent over regular time intervals (e.g., every 10 minutes) via one or more time window fields or dropdown menus that allow users to select.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged (i.e., clicked, swiped, etc.) by the user.

In some embodiments, the display module is in operable communication with the communication module, the habit module, and the timing module to display the alert corresponding to the at least one habit, wherein the alert corresponding to the habit is displayed once the time interval has elapsed.

In some embodiments, habit days are tracked automatically such that once a habit block (i.e., a set of habits) is disabled, the tracking days function will stop until the user enables the habit block. Once the habit block is enabled, the tracking days function will restart. If the user erases or resets a habit word or phrase to start a new habit, the tracking days function will restart back to day 1.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing digital habit reminders via a user computing device, the system comprising:
at least one user computing device in operable connection with a user network;
an application server in operable communication with the user network, the application server configured to host an application system for providing digital habit reminders, the application system having a user interface module for providing access to the application program through the user computing device;
a habit module in communication with the application program, the habit module to permit input of at least one habit and to deliver, via a communication module, an alert associated with the at least one habit to the user computing device; and
a timing module to permit input of a time interval associated with each of the at least one habits, the timing module to transmit the alert, via the communication module, wherein the alert is transmitted at the time interval.

2. The system of claim 1, further comprising a user interface screen, wherein the user interface screen of displays at least one habit training overview display.

3. The system of claim 2, wherein the user interface screen permits a user to acknowledge the at least one habit.

4. The system of claim 2, wherein the user interface screen is displayed on a wearable device.

5. The system of claim 1, wherein the at least one habit training overview includes a reminder title, vibration, or sound which is transmitted when the time interval expires.

6. The system of claim 1, wherein the at least one habit training overview includes a name displayed when the time interval expires.

7. The system of claim 1, wherein a selectable button permits the user to dismiss the alert, or select the alert to view alert details.

8. The system of claim 1, wherein the habit module permits the user to select a maximum number of habit blocks.

9. The system of claim 1, wherein the user interface screen permits the disablement of the user interface screen.

10. The system of claim 9, wherein selecting the disablement of the user interface screen changes the display of the user interface screen.

11. The system of claim 1, wherein the user interface screen permits the enablement of the user interface screen.
A system for providing digital habit reminders via a user computing device, the system comprising:
at least one user computing device in operable connection with a user network;
an application server in operable communication with the user network, the application server configured to host an application system for providing digital habit reminders, the application system having a user interface module for providing access to the application program through the user computing device;
a habit module in communication with the application program, the habit module to permit input of at least one habit and to deliver, via a communication module, an alert associated with the at least one habit to the user computing device; and
a timing module to permit input of a time interval associated with each of the at least one habits, the timing module to transmit the alert, via the communication module, wherein the alert is transmitted at the time interval;
a display module in operable communication with the communication module, the habit module, and the timing module to display the alert corresponding to the at least one habit, wherein the alert corresponding to the habit is displayed once the time interval has elapsed;
a user module to permit the user to input one or more preferences corresponding to the at least one habit and the time interval, wherein the at least one habit and the time interval is stored in the database.

12. The system of claim 11, further comprising a user interface screen, wherein the user interface screen of displays at least one habit training overview display.

13. The system of claim 12, wherein the user interface screen permits a user to acknowledge the at least one habit.

14. The system of claim 13, wherein the user interface screen is displayed on a wearable device.

15. The system of claim 14, wherein the at least one habit training overview includes a reminder title displayed when the time interval expires.

16. The system of claim 15, wherein the at least one habit training overview includes a name displayed when the time interval expires.

17. The system of claim 16, wherein a selectable button permits the user to dismiss the alert.

18. The system of claim 17, wherein the habit module permits the user to select a maximum number of habit blocks.

19. The system of claim 18, wherein the user interface screen permits the disablement of the user interface screen.

20. The system of claim 19, wherein selecting the disablement of the user interface screen changes the display of the user interface screen.
